(19) United States
(12) Patent Application Publication
(10) Pub. No.: US 2015/0245272 A1
(43) Pub. Date: Aug. 27, 2015

(54) Method, Apparatus and Computer Program for Backhaul Management

(71) Applicant: TELEFONAKTIEBOLAGET L M ERICSSON, Stockholm (SE)

(72) Inventors: Bengt Lindoff, Bjarred (SE); Niklas Andgart, Sodra Sandby (SE); Fredrik Nordström, Lund (SE); Andres Reial, Malmo (SE); Yngve Selén, Uppsala (SE)

(21) Appl. No.: 14/432,850

(22) PCT Filed: Oct. 5, 2012
(86) PCT No.: PCT/SE2012/051070

§ 371 Date: Apr. 1, 2015

(51) Int. Cl. H04W 36/30; H04W 72/08

(52) U.S. Cl. CPC H04W 36/30; H04W 72/085

(57) ABSTRACT

There is disclosed a backhaul property managing mechanism configured to collect backhaul properties from at least one network node, wherein the backhaul properties comprises performance metrics for communication with a core network for the respective network node; provide collected backhaul properties to at least one user equipment, UE, being in position where communication with the at least one network node is feasible. A UE, base station, methods therefor and computer program for implementing the methods are also disclosed.

### TECHNICAL FIELD

The present invention generally relates to a method, apparatuses and computer program for backhaul management. Some of the methods and apparatuses concern backhaul-aware communication setup management.

### BACKGROUND

A core network is the central part of a telecommunication network that provides various services to customers who are connected by an access network. An example of an access network is cellular network, or mobile network, such as GSM, WCDMA/HSPA, LTE, etc., which is a radio network distributed over land areas called cells, each served by at least one fixed-location transceiver, known as a cell site or base station. When joined together these cells provide radio coverage over a wide geographic area. This enables a large number of transceivers to communicate with each other and with fixed transceivers anywhere in the network, via base stations, and with nodes in other networks interconnected with the network, even if some of the transceivers are moving through more than one cell during transmission. Other examples of access networks can be based on wired communication or optical fibre communication. The core network normally relies on transmission technologies providing high bandwidth, such as fibre, wired or microwave links.

Wide Area Network can use macrocells, picocells, and/or femtocells in order to offer wireless coverage in an environment with a wide variety of wireless coverage zones, ranging from an open outdoor environment to office buildings, homes, and underground areas. This is often referred to as a heterogeneous network, which is as a network with complex interoperation between macrocell, smaller cells (picocells, femtocells), and also WiFi (WLAN, 802,11x) network elements used together therewith to provide a mosaic of coverage, with handover capability between network elements.

The diversity of possible communication set-ups does not only provide a great variety of possible connections; it also gives a complex selection in some situations. It is therefore a desire to provide an approach of supporting efficient selection.

### SUMMARY

The present invention is based on the understanding that selection of communication pathway, such as handover or device-to-device, D2D, path, may be made not only based on signal strength, as in conventional mobility handling, but also based on other parameters for providing a suitable communication set-up for a particular need at a user equipment, UE. The inventors have found that quality of service, QoS, parameters such as delay, load, capacity, throughput, power consumption, etc., in addition to more conventional parameters such as signal strength, interference, etc., can be taken into account for selecting the suitable communication set-up for the actual situation at the UE. An aggregate event of mobility and QoS, in other respects very much like a handover event, can thus be introduced for selecting and reselecting the communication set-up. The UE can, based on determined backhaul properties of a network node which is communicating with, and possible other candidates for communicating with, select or reselect way of communication. Here, backhaul properties are an aggregation of relevant QoS parameters and conventional parameters, as demonstrated above.

In this disclosure, the term “network node” is used for any of the entities participating in wireless communication in the access network, such as base stations supporting macro, pico, femto, etc. cells, UEs, and access points for wireless local area networks, and the term is chosen for the sake of conciseness instead of “wireless communication enabled network node”.

According to a first aspect, there is provided a backhaul property managing mechanism configured to collect backhaul properties from at least one network node, wherein the backhaul properties comprises performance metrics for communication with a core network for the respective network node; provide collected backhaul properties to at least one user equipment, UE, being in position where communication with the at least one network node is feasible. Here, feasible communication may be judged on any of: signal strength, noise, interference, latency and a combination of these.

The backhaul properties may comprise any of latency in communication between the network node and the core network; load of links between the network node and the core network; load of air interface to be used between the network node and the UE; capacity between the network node and the core network; throughput between the network node and the core network; and any combination of these.

According to a second aspect, there is provided a base station comprising a backhaul property managing mechanism according to the first aspect, being arranged to operate a cell of a cellular wireless communication network where the base station is configured to communicate with UEs within the cell. The collection from the at least one network node of backhaul properties comprises determining backhaul properties of the base station. The provision of collected backhaul properties comprises transmitting the backhaul properties to the at least one UE.

The base station may be arranged to receive a request from the at least one UE for backhaul property information, and in response to such request, transmitting the backhaul properties to the at least one UE.

The base station may be arranged to broadcast the backhaul properties to the at least one UE, and the broadcast comprises the transmitting of the backhaul properties to the at least one UE. The broadcast of the backhaul properties may be configured to be provided through any of master information block, MIB, and system information block, SIB, distributed through a broadcast channel.

The collection from the at least one network node may further comprise receiving backhaul properties from other network nodes, e.g. obtained through WAN and core network protocols.

The base station may be configured to monitor and receive a report from a UE, where the report takes into account backhaul properties of network nodes where communication with the UE is feasible; and perform a communication set-up action in accordance with the received report. A particular advantage of this is that many established base station structures and operations can be reused with the modification that the backhaul management is taken into account. The report may comprise an adjusted channel quality indicator, CQI, signal strength indicator, such as Reference Signal Received Power, RSRP, or Received Signal Code Power, RSCP, or load indicator, such as Reference Signal Received Quality, RSRQ, received chip energy per band power density, Ec/No, where the UE has adjusted any of the channel quality indicator, the signal strength indicator, or the load indicator based on the collected backhaul properties of network nodes where communication with the UE is feasible. Alternatively, the report may comprise compiled backhaul property information, wherein the UE has compiled collected backhaul properties of network nodes where communication with the UE is feasible. The communication set-up action may comprise any of: initiation of handover of the UE to one of the network nodes where communication with the UE is feasible; and initiation of device-to-device, D2D, communication for the UE with one of the network nodes where communication with the UE is feasible. Here, feasible communication may be judged on any of: signal strength, noise, interference, latency and a combination of these.

The at least one network node may comprise any of another base station enabled for operating a macro, pico or femto cell; a UE enabled for device-to-device, D2D, communication; an access point enabled for wireless communication; and any combination of these.

According to a third aspect, there is provided a user equipment, UE, comprising a backhaul property managing mechanism according to the first aspect, being configured to operate in a cell of a cellular wireless communication network where a base station is configured to communicate with UEs within the cell. The collection from the at least one network node of backhaul properties comprises reception of transmitted backhaul properties of the base station and determination of backhaul properties of at least one other network node where communication with the at least one other network node is feasible. The UE comprises a memory, wherein the provision of collected backhaul properties comprises to store the collected properties in the memory.

The UE may have an idle mode when no communication for any service is performed and a connected mode when communication for at least one service is performed, and may be arranged to, also when in the idle mode, keep the memory updated with collected backhaul properties, and, upon transition from the idle mode to the connected mode, initiate connection based on the stored backhaul properties. The provision of collected backhaul properties may comprise to send a report taking into account the collected backhaul properties to the base station. The provision may further comprise adjusting a channel quality indicator, CQI, a signal strength indicator, such as Reference Signal Received Power, RSRP, or Received Signal Code Power, RSCP, or load indicator, such as Reference Signal Received Quality, RSRQ, received chip energy per band power density, Ec/No, based on the collected backhaul properties, wherein the report comprises any of the adjusted channel quality indicator, the signal strength indicator or the load indicator. Alternatively, the provision may further comprise compiling the collected backhaul properties, wherein the report comprises the compiled backhaul property information.

The report may comprise information on a target network node for handover or device to device, D2D, communication.

The UE may comprise a quality of service, QoS, manager configured to determine required properties for communication with core network for a service to be completed; determine network nodes, where communication is feasible, having backhaul properties that match the required properties; and determine the target node from the network nodes having backhaul properties that match the required properties.

According to a fourth aspect, there is provided a method of managing backhaul property for a communication network, the network comprising a base station arranged to operate a cell of the communication network where the base station is configured to communicate with at least one user equipment, UE, within the cell. The method comprises collecting backhaul properties from at least one network node, wherein the backhaul properties comprises performance metrics for communication with a core network for the respective network node; and providing collected backhaul properties to at least one UE being in position where communication with the at least one network node is feasible.

The backhaul properties may comprise any of latency in communication between the network node and the core network; load of links between the network node and the core network; load of air interface to be used between the network node and the UE; capacity between the network node and the core network; throughput between the network node and the core network; battery status of the network node; and any combination of these.

According to a fifth aspect, there is provided a method of a base station, the method comprising the method of managing backhaul property according to the fourth aspect, the base station being arranged to operate a cell of a communication network where the base station is configured to communicate with UEs within the cell. The collecting from the at least one network node of backhaul properties comprises determining backhaul properties of the base station. The providing of collected backhaul properties comprises transmitting the backhaul properties to the at least one UE.

The method may comprise receiving a request from the at least one UE for backhaul property information, and in response to such request, performing the transmitting of the backhaul properties to the at least one UE.

The transmitting of the backhaul properties to the at least one UE may comprise broadcasting the backhaul properties to the at least one UE.

The broadcasting of the backhaul properties may comprise providing the backhaul properties through any of master information block, MIB, and system information block, SIB, distributed through a broadcast channel.

The collecting from the at least one network node may further comprise receiving backhaul properties from other network nodes.

The method may further comprise monitoring and receiving a report from a UE, where the report takes into account backhaul properties of network nodes where communication with the UE is feasible; and performing a communication set-up action in accordance with the received report. The report may comprise an adjusted CQI or signal strength indicator, where the UE has adjusted the channel quality indicator, CQI, or the signal strength indicator based on the collected backhaul properties of network nodes where communication with the UE is feasible. The report may comprise compiled backhaul property information, wherein the UE has compiled collected backhaul properties of network nodes where communication with the UE is feasible.

The communication set-up action may comprise any of initiating handover of the UE to one of the network nodes; and initiating D2D communication for the UE with one of the network nodes.

According to a sixth aspect, there is provided a method of a user equipment, UE, the method comprising the method of managing backhaul property according to the fourth aspect, the UE being configured to operate in a cell of a communication network where a base station is configured to communicate with UEs within the cell. The collecting from the at least one network node of backhaul properties comprises receiving transmitted backhaul properties of the base station and determining backhaul properties of at least one other network node where communication with the at least one other network node is feasible. The UE comprises a memory, wherein the provision of collected backhaul properties comprises to store the collected properties in the memory.

The UE may have an idle mode, when no communication for any service is performed, and a connected mode, when communication for at least one service is performed, and may be arranged to, also when in the idle mode, keep the memory updated with collected backhaul properties, and, upon transition from the idle mode to the connected mode, initiate connection based on the stored backhaul properties. The providing of collected backhaul properties may comprise sending a report formed by taking into account the collected backhaul properties to the base station. The providing may further comprise adjusting a channel quality indicator, CQI, a signal strength indicator, such as Reference Signal Received Power, RSRP, or Received Signal Code Power, RSCP, or load indicator, such as Reference Signal Received Quality, RSRQ, received chip energy per band power density, Ec/No, based on the collected backhaul properties, wherein the report comprises the adjusted channel quality indicator, signal strength indicator or load indicator. The providing may further comprise compiling the collected backhaul properties, wherein the report comprises the compiled backhaul property information.

The report may comprise information on a target network node for handover or D2D communication. The report may comprise a representation of an event.

The method may further comprise determining required properties for communication with core network for a service to be completed; determining network nodes, where communication is feasible, having backhaul properties that match the required properties; and determining the target node from the network nodes having backhaul properties that match the required properties.

According to a seventh aspect, there is provided a computer program comprising computer-executable program code which, when downloaded and executed by a processor of an entity according to any of the first to third aspects, causes the entity to perform the method according to any of the fourth to sixth aspects.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings.

FIG. 1 schematically illustrates a part of a cellular wireless communication system for providing an access network, and elements that may be involved in communication with a network node according to an embodiment.

FIG. 2 is a signal diagram schematically illustrating information transmission scenarios according to an embodiment.

FIG. 3 is a flow chart schematically illustrating functional behaviour of a backhaul property managing mechanism, and a corresponding method, according to an embodiment.

FIG. 4 is a flow chart schematically illustrating functional behaviour of a base station, and a corresponding method, according to an embodiment.

FIG. 5 is a flow chart schematically illustrating functional behaviour of a UE, and a corresponding method, according to an embodiment.

FIG. 6 is a flow chart schematically illustrating functional behaviour of a UE when in idle state.

FIG. 7 schematically illustrates a network node having backhaul capability via a backbone network of the cellular communication network.

FIG. 8 schematically illustrates a network node enabled to work according to a device-to-device, D2D communication mode within a cellular communication system comprising a macro base station, wherein the network node also has backhaul capability via a second communication network distinct from a backbone network of the cellular communication network.

FIG. 9 is a block diagram schematically illustrating a computer-readable medium and a processing device.

### DETAILED DESCRIPTION

In the following description, the term “UE” has been used for the sake of brevity, and the term should be construed as any device able to communicate wirelessly with network nodes of a cellular wireless communication system, such as for example cellphones (including also smartphones, screenpads with cellular communication capability, etc.), modems (including computers such as laptops, PLCs, controllers etc. with cellular communication capability), sensor and/or actuator devices with cellular communication capability, vending machines (including ticket machines, machines providing goods or services, etc.), access control stations (such as for door or gate access control, check-in stations, etc.), payment stations, automated information desks, vehicles, vessels, construction equipment, electronic road signs, speed cameras, asset management and/or monitoring devices, etc. with cellular communication capability, and similar devices.

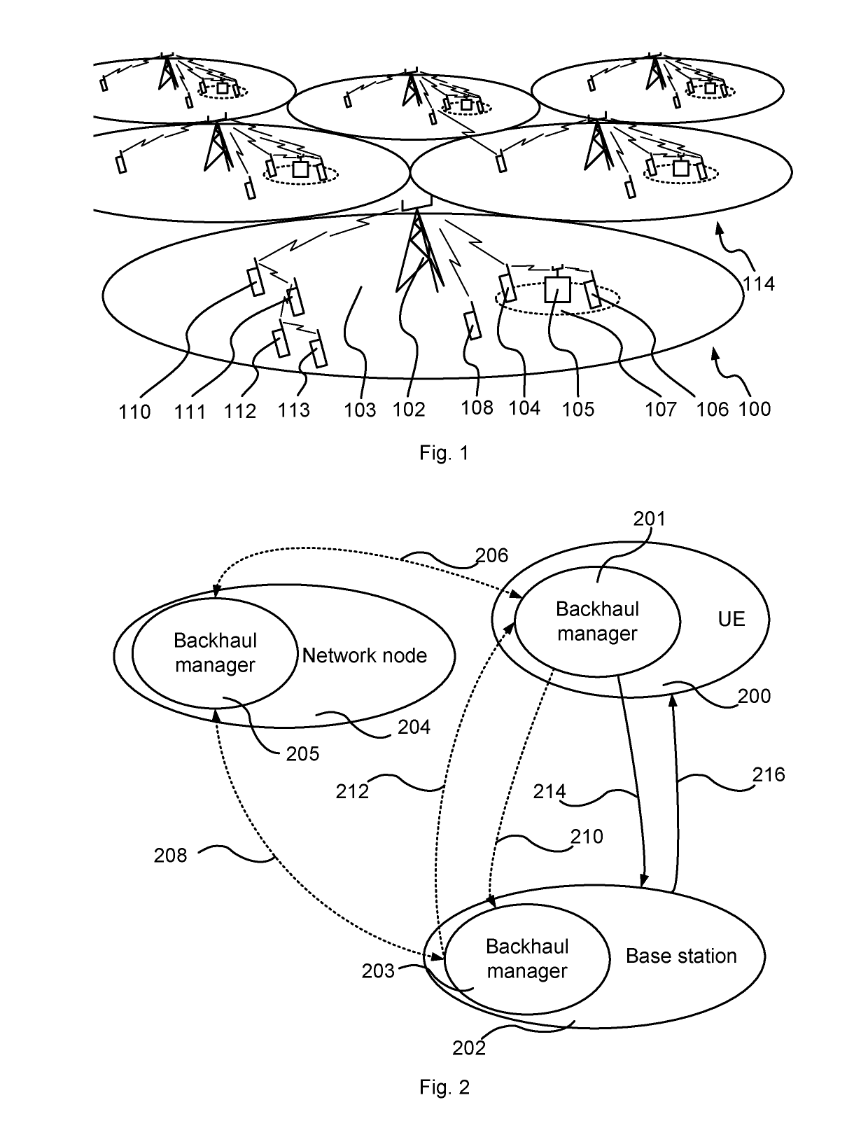

FIG. 1 schematically illustrates a part 100 of a cellular wireless communication system for providing an access network, and elements that may be involved in communication with a network node according to an embodiment. A base station 102 operates a macrocell 103, and a number of devices 104, 105, 106, 108, 110, 111, 112, 113 are assumed to operate within or close to the macrocell 103. A plurality of similar cells 114 are also provided in the wireless cellular communication system. A UE of the cellular wireless communication system may gain access and/or desired communication through different ways. For example: the UE 108 gains access through the base station 102 as also the UE 110, the UE 106 gains access through a base station 105 which operates a femto cell 107 and UE 104 can be seen as making a handover from the base station 102 to the base station 105, the UE 111 gains communication and/or access through device-to-device, D2D, communication with the UE 110 and thereby access to the base station 102, the UEs 112 and 113 similarly also gains communication and/or access through D2D communication using multihop. These communication ways are given as examples here for the understanding of both the complexity in selecting the way to communicate and the demonstrated improvements in relation to this.

Some of the devices 104, 105, 106, 108, 110, 111, 112, 113 may have communication capabilities other than those provided by the access network demonstrated above. For example, the UE 112 may at a moment also be connected to a wired or wireless network distinct from the access network of the cellular wireless communication system, which gives that UE 112 different backhaul capabilities than those provided only by the access network of the cellular wireless communication system. Considering that the backhaul properties of the UE 112 may give e.g. low latency, high bandwidth, and/or low load, etc. for access to a core network, the UE 111 may, when desired service requires any of those properties for connecting to the core network, benefit from selecting D2D communication with the UE 112, which enables relaying to the core network via its connection to the wired or wireless network, instead of a connection via the UE 110 or directly to the base station 102. Similar applies for the UE 104 which for the handover decision not only may consider signal strength properties of the base stations 102 and 105, but also backhaul capabilities of them in relation to a service desired at UE 104. In the example given above, the capabilities are indicated suggesting to achieve high performance communication, but the approach is also suitable for low rate communication, but where for example low power consumption or low generation of interference is desired. For such a case, the routing of the communication is based on any backhaul capability that is enough for the service, and the selection therefrom is made such that power consumption or generation of interference is as low as possible. Thus, what is considered is the match between fulfillment of the requirements of the service and the backhaul capabilities. For enabling the matching of the service and the backhaul properties, a backhaul property managing mechanism is introduced. FIGS. 2 to 6 can be considered for understanding the functional behaviour of the backhaul property managing mechanism according to its different contexts. The backhaul property managing mechanism collects backhaul properties from any network node of interest. The evident collection, where reasonable, is of the entity that is holding the backhaul property managing mechanism. Further, when possible, the collection is made by receiving information on backhaul properties from other entities, e.g. D2D mates, base stations within signal reach, etc. The collected backhaul properties, i.e. from one or more entities, are provided to the UE which has to match it with its desired service. From a perspective of an entity that is not the UE, it is made by transmissions, and from a perspective of the UE which has to match it with its desired service, it is made by providing the information from the backhaul property managing mechanism to the mechanism making the selection of communication way. The backhaul properties can comprise any of, sole or in combination, latency in communication between the entity and the core network, load of links between the entity and the core network, load of air interface to be used between the network node and the UE, capacity between the entity and the core network, throughput between the entity and the core network, etc. Power consumption issues may also be involved. That is, a battery operated entity may put energy consumption constraints into the properties while an entity connected to mains may omit such constraints. Here, the latency can be considered in different ways depending on the type of communication, and an example is a delay between transmission of a packet and the reception of an acknowledgement on the packet. The load of links can also be considered in different ways depending on the type of communication loading the backhaul, and examples are percentage of resources per time occupied, number of users currently or recently using the backhaul, etc. The load of the air interface can be considered similar to the load of the links where examples can be capacity, bandwidth, throughput, etc. Also interference generation issues may be involved. That is, an entity in an environment prone to interference may have constraints in view thereof for wireless operations. These further considerations are either reflected in the backhaul properties as demonstrated above, or given separately. The network node providing its own backhaul properties', e.g. by transmitting them to other network nodes, normally knows the current load of the air interface at its position. For example, the network node may know the amount of occupied and free resource elements, the number of UEs it is being in communication with over the air interface, the allocated or occupied capacity for these UEs, etc. Based on this, one or more metrics indicating the load can be provided, e.g. as a part of the backhaul properties that are provided.

FIG. 2 is a signal diagram schematically illustrating information transmission scenarios according to an embodiment. For the simplified understanding, only a UE 200 on which the service is to be provided to a user, a base station 202 which represents a portion of the traditional access network of the cellular wireless communication system, and a network node 204 which may be an arbitrary node working in the wireless cellular communication system, i.e. a UE or another base station such as a macro, pico or femto base station, etc. Each of the entities 200, 202, 204 has a backhaul manager 201, 203, 205 similar to the above demonstrated backhaul property managing mechanism.

The arrows in FIG. 2 schematically illustrates signalling, where the dotted arrows indicate backhaul property information exchange and the solid lines indicate event signalling in connection with the selection of communication way. Thus, arrow 206 indicates exchange of backhaul property information between the backhaul managers 201 and 205. The exchange can include signalling such as a request, a transmission of the information and acknowledgement of the information. The exchange can also be based on that each entity broadcasts the information and the other entities simply pick up the information and store it, if considered relevant, i.e. if it comes from a node that may be a candidate for communication. Similar criterion applies to arrow 208 which indicates such exchange between the network node 204 and the base station 202. Arrow 210 indicates a request for backhaul property information from the UE 200 to the base station 202, and the arrow 212 indicates the transmitted response from the base station 202 to the request. The solid arrow 214 indicates a report sent from the UE 200 to the base station 202, where the report can include a target node for communication, i.e. for handover or for setting up D2D communication. The report can also comprise an adjusted channel quality indicator, CQI, or adjusted signal strength indicator, where the adjustment is made in view of collected backhaul properties. Similar adjustment can be made on some signal strength indicator, such as Reference Signal Received Power (RSRP), Received Signal Code Power (RSCP), etc., or load indicator, such as Reference Signal Received Quality (RSRQ), received chip energy per band power density (Ec/No), etc. The adjustment can be made based on adjustment factors. The adjustment can be implemented using a look-up table where the backhaul properties are mapped together with actual CQI and/or signal strength indicators. An advantage of this approach is that it can reuse existing reporting and communication setup and reconfiguration mechanisms, and also be compatible with network equipment that lacks any backhaul managing mechanism. The report can also comprise a compilation of collected backhaul properties. That is, the control of the selection can then be moved from the UE to the base station, which in turn optionally also can take into account properties for optimising some communication in the network. The solid arrow 216 indicates signalling from the base station which can be for initiating handover or assisting D2D communication setup.

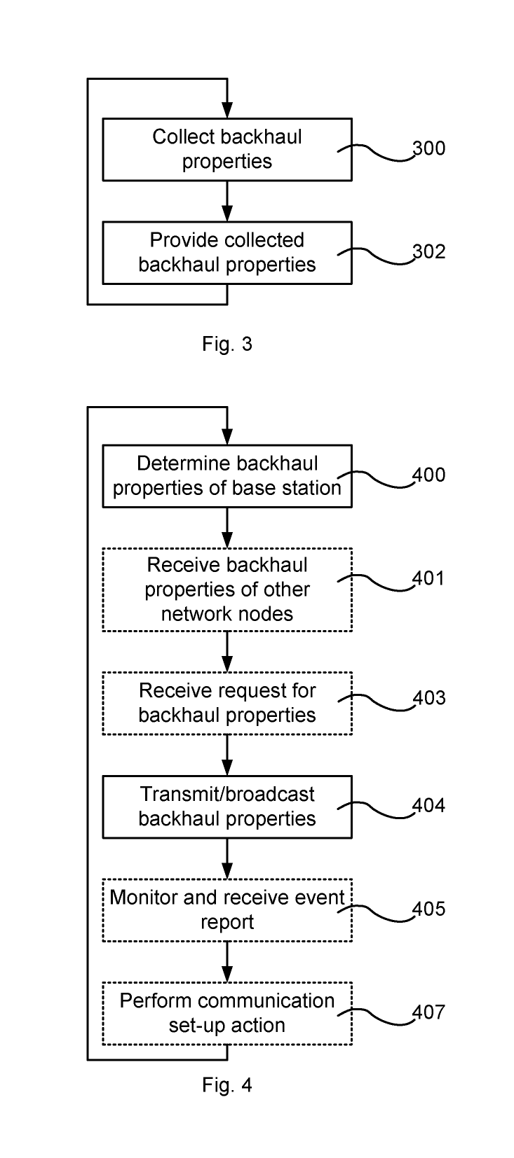

FIG. 3 is a flow chart schematically illustrating a method of managing backhaul properties according to an embodiment. Backhaul properties are collected 300 from at least one network node. The at least one network node can include self-evaluation and/or receiving information from other network nodes within proper signal reach, as demonstrated above. Also the backhaul properties are as demonstrated above. The collected backhaul properties are then provided 302 to at least one UE. The UE will then be able to match requirements of its service with the backhaul properties and select a suitable communication setup.

FIG. 6 is a flow chart schematically illustrating a method for a UE in idle mode. Backhaul properties of nearby network nodes, i.e. where communication is feasible judged on any of: signal strength, noise, interference, latency and a combination of these, are received 601 and preferably stored such that the information on the properties is available for further use. Since the UE is in idle mode, no communication is ongoing, and the backhaul is not critical at the moment. However, the UE determines 602 whether there is a need to set up a connection. If not, the UE continues to monitor 601 backhaul properties for respective network node within reach. If there is a need to set up a connection, the UE determines the service to be set up and, based on that, initiates 603 setup of a connection based on the backhaul properties as demonstrated herein. The initiation can be done similar to traditional techniques, i.e. a Random Access (RA) is transmitted using a RA signature associated with the chosen network node, but with the selection of network node being made based on the backhaul properties.

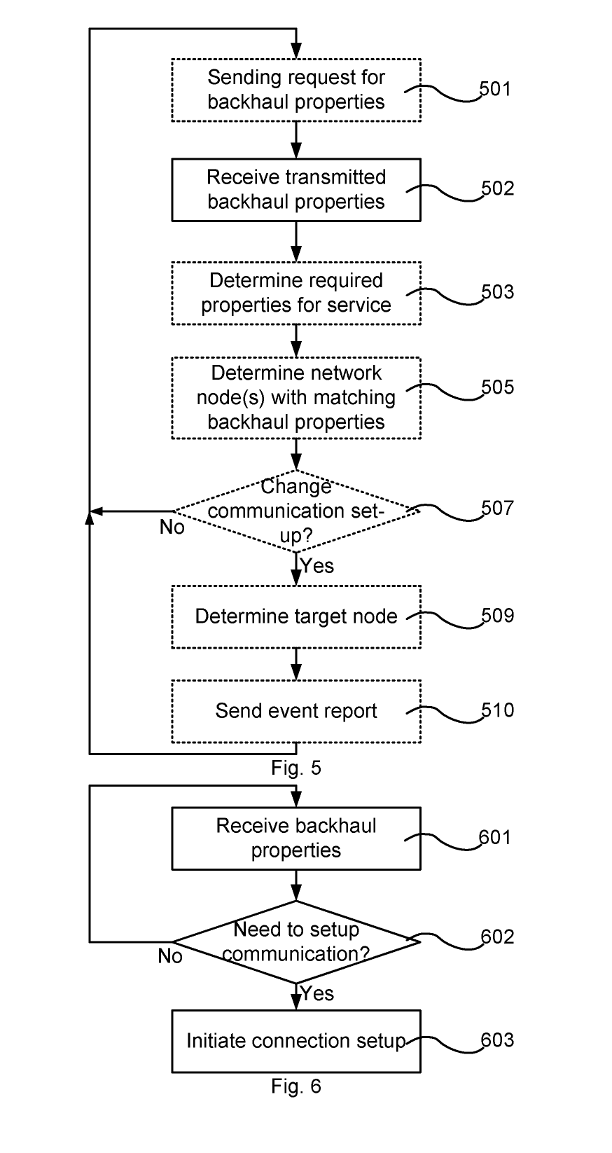

The following description with reference to FIGS. 4 and 5 assumes that the UE is in a connected state, contrary to the idle state discussed above. A backhaul property report can be provided from a UE to a base station or network node which based thereupon can prepare for suitable communication setup, e.g. handover or D2D communication being assisted.

FIG. 4 is a flow chart schematically illustrating a method according to an embodiment, suitable for implementing in a network node acting as a base station. Backhaul properties for the base station are determined 400. Optionally, backhaul properties of other network nodes are also determined by receiving 401 backhaul information from them. The collected backhaul information is then transmitted 404, which either can be made as a broadcast such that any UE, or other network nodes also performing this method, is able to receive the information, or be transmitted to a UE upon receiving 403 a request for the information from that UE. The base station can also monitor 405, and receive when occurring, an event report from a UE where the UE provides information on preferred communication set up or at least information for determining a suitable communication setup. Based on the event report from the UE, the base station can then perform 407 a communication setup action, e.g. where handover is initiated or D2D communication is assisted. These two steps can be compared to normal handover procedure, but one difference is that where normal handover procedure focus on signal characteristics, this procedure focus on backhaul properties (although signal properties of course still are important; preferred backhaul properties do not work without proper signals). A further difference is that handover is not the only option for selecting the communication setup. Thus, the procedure is different in nature, but should be easier understood when considered in light of the handover procedure.

FIG. 5 is a flow chart schematically illustrating a method according to an embodiment, suitable for implementing in a network node acting as a UE. The UE receives 502 transmitted backhaul properties. These can be broadcasted from network nodes in the vicinity, or be transmitted to the UE as a response to the UE sending 501 a request for backhaul properties. The UE can also determine 503 required backhaul properties for a service it is about to provide. This step can of course be made before sending the request 501 and receiving 502 the backhaul properties, and can also be inherent in the general operation of the UE and not be considered as any expressed action. The received backhaul properties from one or more network nodes are checked and from the one or more network nodes, one or more network nodes having matching network properties to the required backhaul properties are determined 505. If there is an established communication setup, a determination 507 on change of that can be made. If no change is determined to be made, i.e. the established communication setup is considered to work well, the procedure continues to monitor backhaul capabilities as indicated by the “No” arrow in FIG. 5. However, if it is detected that the currently established communication setup could be out-performed by another setup, a target network node may be determined 509, and an event report is sent 510 for establishing a new communication setup.

This provides the possibility to transmit a handover event that is related to backhaul properties. Traditionally, handover events in cellular access networks are based on signal strengths and relation between signal strengths or load for different cells. For example, a traditional event can be where signal from Cell A is stronger than Cell B or signal from Cell A is stronger than a threshold, seen from the UE. Consider now a modified event that for example is that Cell A has backhaul properties that, for the needs of the UE, are better than backhaul properties of Cell B, or Cell A has backhaul properties that, for the actual needs of the UE, are better than a threshold, or Cell A has the best backhaul properties for the actual needs of the UE. Backhaul properties can simply be given by a single parameter, which for all services is better or worse according to the example above. The situation can also be more complex, where backhaul properties are considered for the current used service and if the backhaul properties comprise a set of parameters which are evaluated in view of the used service, e.g. by weighting or by discarding certain backhaul opportunities because some parameter does not fulfil the requirements of the service. In some embodiments, information about the used service, e.g. speech, video, streaming, browsing, applications (apps), email services, etc., is added in the event report, and different representation, e.g. numbers or letters, can be used for determine the specific handover event and service. For example, events can be denoted 3Q or Q3, 3Qe (email), Q3b (browsing), 3Qa (apps). This would be a legacy from the notation given in 3GPP Technical Specification, TS 36.331, Release 11, V11.1.0, chapter 5.5 about Measurements, and in particular sub-chapter 5.5.4 about Measurement report triggering. An advantage of such legacy is facilitated integration in existing structures and protocols. The reporting and/or measurement related actions can for the same reasons be implemented similar as described by sub-chapters 5.5.5 and 5.5.6 of the above referenced document.

In the disclosure above, the term “required backhaul properties” has been used. Many times, there are desired backhaul properties for making the service work well, and there are required backhaul properties for making the service work at all, and sometimes different degrees on desired backhaul properties. Now, when the reader has understood the principles of matching and selection based on collected backhaul properties, it can also be indicated that such different levels ranging from required backhaul properties to the most desirable backhaul properties can be taken into account for the selection. Also, many times there are several different properties that are desired to meet a certain quality criterion, but cannot all be provided by one network node. Consider for example that low latency and high capacity are desired, but Node 1 provides low latency but not that high capacity, while Node 2 provides high capacity, but the latency is a bit higher. Thus, the matching mechanism may also comprise capability for such multi-parameter judgements.

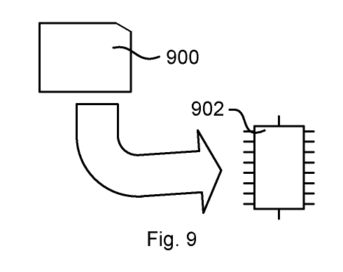

The methods according to the present invention is suitable for implementation with aid of processing means, such as computers and/or processors, especially for the case where the controller demonstrated above is a digital signal processor. Therefore, there is provided computer programs, comprising instructions arranged to cause the processing means, processor, or computer to perform the steps of any of the methods according to any of the embodiments described above. The computer programs preferably comprises program code which is stored on a computer readable medium 900, as illustrated in FIG. 9, which can be loaded and executed by a processing means, processor, or computer 902 to cause it to perform the methods, respectively, according to embodiments of the present invention, preferably as any of the embodiments described above. The computer 902 and computer program product 900 can be arranged to execute the program code sequentially where actions of the any of the methods are performed stepwise. However, the computer 902 and computer program product 900 can also be arranged to execute the program code on a real-time basis where actions of the any of the methods are performed when called upon and data for performing the respective action is available. The processing means, processor, or computer 902 is preferably what normally is referred to as an embedded system. Thus, the depicted computer readable medium 900 and computer 902 in FIG. 9 should be construed to be for illustrative purposes only to provide understanding of the principle, and not to be construed as any direct illustration of the elements.

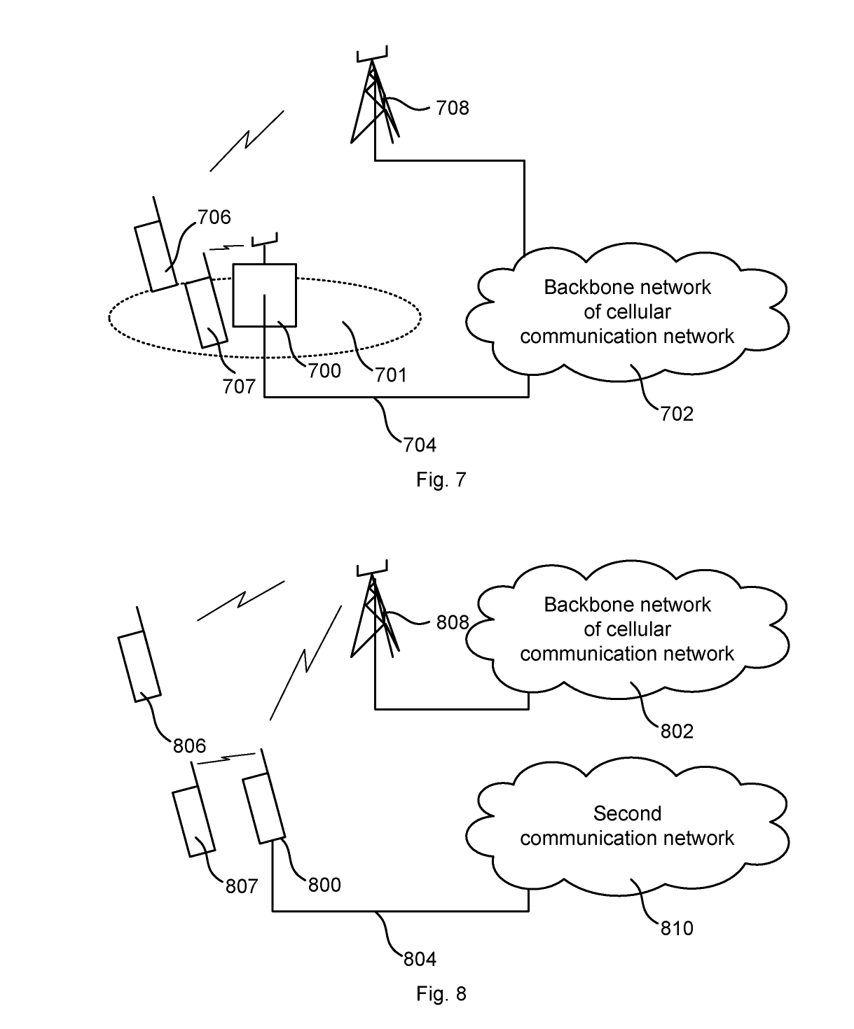

For the understanding of the contexts in which different nodes and their different backhaul capabilities provides different backhaul properties, FIGS. 7 and 8 illustrate examples.

FIG. 7 schematically illustrates a network node 700 having backhaul capability to a backbone network 702 of the cellular communication network. For example, the network node may be a base station operating a femto cell 701, and the backhaul capability is provided e.g. through a wired 704 connection. Considering a UE 706 desiring to provide a service requiring communication with the backbone network 702, e.g. to access the Internet via a gateway provided through the backbone network 702, may here have several options to establish communication. This can include using any of the following communication setups: via a macro base station 708 and the backbone network 702; communication via the femto base station 700 through the connection 704 and the backbone network 702; and via another UE 707 through D2D communication and then via the established communication of the UE 707 via the femto base station 700 through the connection 704 and the backbone network 702. The backhaul properties of these communication options are collected, and a selection suitable for the required service is made, based on the backhaul properties, and optionally other preferences such as power consumption, interference generation, etc., and of course signal properties making communication feasible.

FIG. 8 schematically illustrates a network node 800 enabled to work according to a device-to-device, D2D communication mode within a cellular communication system comprising a macro base station 808, wherein the network node 800 also has backhaul capability, via e.g. a wired connection 804, through a second communication network 810 distinct from a backbone network 802 of the cellular communication network. Considering a UE 806 desiring to provide a service where access to the Internet, similar to the example of FIG. 7, may here have the options to establish communication with the following communication setups: via the established via a macro base station 808 and the backbone network 802 and a gateway of the backbone network 802 to the Internet, communication via the UE 800 through D2D communication through the connection 804 and the second communication network 810 and a gateway of the second communication network 810 to the Internet, and via another UE 807 through D2D communication and then via the established communication of the UE 807 via the UE 800 through the connection 704 and the second communication network 810 and a gateway of the second communication network 810 to the Internet. The backhaul properties of these communication options are collected, and a selection suitable for the service is made based on the backhaul properties, and optionally on other preferences such as power consumption, interference generation, etc., and of course signal properties making communication feasible.

1-39. (canceled)

40. A backhaul property managing mechanism comprising a processor and a memory, said memory containing instructions executable by said processor whereby said mechanism is configured to:
collect backhaul properties from at least one network node, wherein the backhaul properties comprises performance metrics for communication with a core network for the respective network node; and
provide collected backhaul properties to at least one user equipment (UE) being in a position where communication with the at least one network node is feasible.

41. The backhaul property managing mechanism according to claim 40, wherein the backhaul properties comprises any of:
latency in communication between the network node and the core network;
load of links between the network node and the core network;
load of air interface to be used between the network node and the UE;
capacity between the network node and the core network;
throughput between the network node and the core network; and
any combination of these.

42. A base station configured to operate a cell of a cellular wireless communication network and communicate with UEs within the cell, the base station comprising
a backhaul property managing mechanism comprising a processor and a memory, said memory containing instructions executable by said processor whereby said mechanism configured to:
collect backhaul properties from at least one network node, wherein the backhaul properties comprises performance metrics for communication with a core network for the respective network node; and
provide collected backhaul properties to at least one UE being in a position where communication with the at least one network node is feasible;
wherein the collection from the at least one network node of backhaul properties comprises determining backhaul properties of the base station; and
wherein the provision of collected backhaul properties comprises transmitting the backhaul properties to the at least one UE.

43. The base station according to claim 42, wherein the base station is further configured to:
receive a request from the at least one UE for backhaul property information; and
in response to such request, transmit the backhaul properties to the at least one UE.

44. The base station according to claim 42, wherein the base station is further configured to broadcast the backhaul properties to the at least one UE, wherein the broadcast comprises the transmitting of the backhaul properties to the at least one UE.

45. The base station according to claim 44, wherein broadcast of the backhaul properties is configured to be provided through a master information block (MIB) and/or a system information block (SIB) distribution through a broadcast channel.

46. The base station according to claim 42, wherein the collection from the at least one network node further comprises receiving backhaul properties from other network nodes.

47. The base station according to claim 42, wherein the at least one network node comprises any of:
another base station enabled for operating a macro, pico or femto cell;
a UE enabled for device-to-device (D2D) communication;
an access point enabled for wireless communication; and
any combination of these.

48. The base station according to claim 42, further configured to:
monitor and receive a report from a UE, wherein the report takes into account backhaul properties of network nodes where communication with the UE is feasible; and
perform a communication set-up action in accordance with the received report.

49. The base station according to claim 48,
wherein the report comprises an adjusted:
channel quality indicator (CQI)
signal strength indicator; and/or
load indicator; and
wherein the UE has adjusted the channel quality indicator, the signal strength indicator and/or the load indicator based on the collected backhaul properties of network nodes where communication with the UE is feasible.

50. The base station according to claim 49,
wherein the signal strength indicator comprises a Reference Signal Received Power (RSRP) or Received Signal Code Power (RSCP); and/or
wherein the load indicator comprises a Reference Signal Received Quality (RSRQ) or received chip energy per band power density (Ec/No).

51. The base station according to claim 48,
wherein the report comprises compiled backhaul property information; and
wherein the UE has compiled collected backhaul properties of network nodes where communication with the UE is feasible.

52. The base station according to claim 48, wherein the communication set-up action comprises:
initiation of handover of the UE to one of the network nodes where communication with the UE is feasible; and/or
initiation of device-to-device (D2D) communication for the UE with one of the network nodes where communication with the UE is feasible.

53. A user equipment (UE) configured to operate in a cell of a cellular wireless communication network wherein a base station is configured to communicate with UEs within the cell, the UE comprising:
a backhaul property managing mechanism comprising a processor and a memory, said memory containing instructions executable by said processor whereby said mechanism is configured to:
collect backhaul properties from at least one network node, wherein the backhaul properties comprises performance metrics for communication with a core network for the respective network node; and
provide collected backhaul properties to at least one UE being in a position where communication with the at least one network node is feasible;
wherein the collection from the at least one network node of backhaul properties comprises reception of transmitted backhaul properties of the base station and determination of backhaul properties of at least one other network node where communication with the at least one other network node is feasible; and
wherein the provision of collected backhaul properties comprises to store the collected properties in the memory.

54. The UE according to claim 53, further configured to:
have an idle mode when no communication for any service is performed; and
have a connected mode when communication for at least one service is performed;
when in the idle mode, keep the memory updated with collected backhaul properties; and
upon transition from the idle mode to the connected mode, initiate a connection based on the stored backhaul properties.

55. The UE according to claim 53, comprising a quality of service (QoS) manager configured to:
determine required properties for communication with a core network for a service to be completed;
determine network nodes, where communication is feasible, having backhaul properties that match the required properties; and
determine a target node from the network nodes having backhaul properties that match the required properties.

56. The UE according to claim 53, wherein the provision of collected backhaul properties further comprises to send a report taking into account the collected backhaul properties to the base station.

57. The UE according to claim 56,
wherein the provision further comprises adjusting based on the collected backhaul properties:
a channel quality indicator (CQI)
a signal strength indicator; and/or
a load indicator; and
wherein the report comprises the adjusted channel quality indicator, the signal strength indicator and/or the load indicator.

58. The UE according to claim 57,
wherein the signal strength indicator comprises a Reference Signal Received Power (RSRP) or Received Signal Code Power (RSCP); and/or
wherein the load indicator comprises a Reference Signal Received Quality (RSRQ) or received chip energy per band power density (Ec/No).

59. The UE according to claim 56,
wherein the provision further comprises compiling the collected backhaul properties; and
wherein the report comprises the compiled backhaul property information.

60. The UE according to claim 56, wherein the report comprises information on a target network node for handover or device to device (D2D) communication.

61. A method of managing a backhaul property for a communication network, the network comprising a base station configured to operate a cell of the communication network and configured to communicate with at least one user equipment (UE) within the cell, the method comprising
collecting backhaul properties from at least one network node, wherein the backhaul properties comprises performance metrics for communication with a core network for the respective network node; and
providing collected backhaul properties to at least one UE being in position where communication with the at least one network node is feasible.

62. The method according to claim 61, wherein the backhaul properties comprises any of:
latency in communication between the network node and the core network;
load of links between the network node and the core network;
load of air interface to be used between the network node and the UE;
capacity between the network node and the core network;
throughput between the network node and the core network;
battery status of the network node; and
any combination of these.

63. The method of claim 61, wherein the method is implemented by the base station, and wherein the collecting from the at least one network node of backhaul properties comprises determining backhaul properties of the base station, and wherein the providing of collected backhaul properties comprises transmitting the backhaul properties to the at least one UE.

64. The method according to claim 63, the method further comprising:
receiving a request from the at least one UE for backhaul property information; and
in response to such request, performing the transmitting of the backhaul properties to the at least one UE.

65. The method according to claim 63, wherein transmitting of the backhaul properties to the at least one UE comprises broadcasting the backhaul properties to the at least one UE.

66. The method according to claim 63, wherein broadcasting of the backhaul properties comprises providing the backhaul properties through a master information block (MIB) and/or a system information block (SIB) distribution through a broadcast channel.

67. The method according to claim 63, wherein the collecting from the at least one network node further comprises receiving backhaul properties from other network nodes.

68. The method according to claim 63, the method further comprising:
monitoring and receiving a report from a UE, wherein the report takes into account backhaul properties of network nodes where communication with the UE is feasible; and
performing a communication set-up action in accordance with the received report.

69. The method according to claim 68,
wherein the report comprises an adjusted:
channel quality indicator (CQI)
signal strength indicator; and/or
load indicator; and
wherein the UE has adjusted the channel quality indicator, the signal strength indicator and/or the load indicator based on the collected backhaul properties of network nodes where communication with the UE is feasible.

70. The method according to claim 69,
wherein the signal strength indicator comprises a Reference Signal Received Power (RSRP) or Received Signal Code Power (RSCP); and/or
wherein the load indicator comprises a Reference Signal Received Quality (RSRQ) or received chip energy per band power density (Ec/No).

71. The method according to claim 68,
wherein the report comprises compiled backhaul property information; and
wherein the UE has compiled collected backhaul properties of network nodes where communication with the UE is feasible.

72. The method according to claim 68, wherein the communication set-up action comprises:
initiating handover of the UE to one of the network nodes; and/or
initiating D2D communication for the UE with one of the network nodes.

73. The method of claim 61, wherein the method is implemented by the UE managing a backhaul property implemented by a user equipment (UE) of said at least one UE within the cell, and
wherein the collecting from the at least one network node of backhaul properties comprises receiving transmitted backhaul properties of the base station and determining backhaul properties of at least one other network node where communication with the at least one other network node is feasible; and
wherein the providing of collected backhaul properties comprises storing the collected backhaul properties in a memory of the UE.

74. The method according to claim 73,
wherein the UE has an idle mode when no communication for any service is performed and a connected mode when communication for at least one service is performed; and
the method further comprises:
keeping the memory updated with collected backhaul properties also when in the idle mode; and
initiating a connection based on the stored backhaul properties upon transition from the idle mode to the connected mode.

75. The method according to claim 73, the method further comprising:
determining required properties for communication with a core network for a service to be completed;
determining network nodes, where communication is feasible, having backhaul properties that match the required properties; and
determining a target node from the network nodes having backhaul properties that match the required properties.

76. The method according to claim 73, wherein the providing of collected backhaul properties further comprises sending a report formed by taking into account the collected backhaul properties to the base station.

77. The method according to claim 76,
wherein the providing further comprises adjusting based on the collected backhaul properties:
a channel quality indicator (COI)
a signal strength indicator; and/or
a load indicator; and
wherein the report comprises the adjusted channel quality indicator, the signal strength indicator and/or the load indicator.

78. The method according to claim 77,
wherein the signal strength indicator comprises a Reference Signal Received Power (RSRP) or Received Signal Code Power (RSCP); and/or
wherein the load indicator comprises a Reference Signal Received Quality (RSRQ) or received chip energy per band power density (Ec/No).

79. The method according to claim 76,
wherein the providing further comprises compiling the collected backhaul properties; and
wherein the report comprises the compiled backhaul property information.

80. The method according to claim 76, wherein the report comprises information on a target network node for handover or D2D communication.

81. The method according to claim 76, wherein the report comprises a representation of an event.

82. A computer program product stored on a non-transitory, computer readable medium and comprising program instructions, which when executed by at least one processor, cause the at least one processor to:
collect backhaul properties from at least one network node, wherein the backhaul properties comprises performance metrics for communication with a core network for the respective network node; and
provide collected backhaul properties to at least one UE being in position where communication with the at least one network node is feasible.

83. The computer program product of claim 82,
wherein the at least one processor is comprised in a base station, wherein the base station is configured to operate a cell of a communication network and configured to communicate with UEs within the cell;
wherein the collecting from the at least one network node of backhaul properties comprises determining backhaul properties of the base station; and
wherein the providing of collected backhaul properties comprises transmitting the backhaul properties to the at least one UE.

84. The computer program product of claim 82,
wherein the at least one processor is comprised in a user equipment (UE), wherein the UE is configured to operate in a cell of a communication network and wherein a base station is configured to communicate with UEs within the cell;
wherein the collecting from the at least one network node of backhaul properties comprises receiving transmitted backhaul properties of the base station and determining backhaul properties of at least one other network node where communication with the at least one other network node is feasible; and
wherein the providing of collected backhaul properties comprises storing the collected backhaul properties in a memory of the UE.
